(19) United States
(12) Patent Application Publication
(10) Pub. No.: US 2018/0209890 A1
(43) Pub. Date: Jul. 26, 2018

(54) DIESEL PARTICULATE FILTER INSPECTION MACHINE

(71) Applicant: EXHAUST FILTER INSPECTIONS, LLC, Winter Park, FL (US)

(72) Inventors: BRYAN CASE, MISSION VIEJA, CA (US); GREG LUKINS, SANFORD, FL (US); DAVID BUTLER, WINTER PARK, FL (US)

(21) Appl. No.: 15/878,201

(22) Filed: Jan. 23, 2018

Related U.S. Application Data
(60) Provisional application No. 62/449,132, filed on Jan. 23, 2017.

(51) Int. Cl. G01N 15/08; B01D 46/44; B01D 46/00

(52) U.S. Cl. CPC G01N 15/0806; G01N 15/0826; F04D 25/08; B01D 46/446; B01D 46/0086; B01D 46/444

(57) ABSTRACT

A diesel particulate filter inspection machine. The machine comprises a test chamber for receiving a diesel particulate filter and a fan for drawing air from outside the chamber through the filter. An air flow measuring device measures air flow through the filter and compares a measured air flow with a predetermined air flow threshold value to determine whether the diesel particulate filter needs further cleaning.

### CROSS REFERENCE TO RELATED APPLICATIONS

The present application claims priority under 35 U.S.C. 119(e) to the provisional patent application filed on Jan. 23, 2017 and assigned application number 62/449,132. This provisional patent application is incorporated in in its entirety herein.

### BACKGROUND OF THE INVENTION

During operation, diesel trucks emit diesel particulate matter (DPM) that has been shown to be harmful to human health and air quality. Consequently, diesel particulate filters (DPFs) were introduced in the mid 2000's to keep DPM from entering the atmosphere as pollutants. The DPF comprises a cylindrical shell (made of a metallic material, for example) enclosing a ceramic filter element.

Diesel particulate filters are now required emissions equipment on all diesel engines to prevent soot and other by-products of fuel combustion from release into the atmosphere as pollutants. On large trucks, these filters need to be cleaned regularly to meet approved design emissions specifications, prevent a reduction in fuel economy and prevent possible engine damage.

Fuel economy begins to drop when the filter is only about half full, so it is economically important to clean the filter as part of regular maintenance. Cleaning is also more cost effective than replacing the filter because these filters are expensive.

However, current methods for cleaning diesel particulate filters can crack or weaken the filter in as few as two cleanings. Cracked filters can no longer trap particulates and they must be replaced. Replacement is also indicated when the filter becomes so clogged that cleaning is no longer effective.

To determine if a filter is cracked or clogged, the filter must be inspected after cleaning.

Currently, the inspection is a manual process performed by a human operator. The operator places the filter in front of a high velocity fan, and with the fan running, the back-pressure of the air entering the filter is displayed on an analog manometer dial. Filters that have not been completely cleaned will not permit sufficient air to pass through. Air flows either below or above design specifications of the original equipment manufacturer (OEM) indicate a failed filter.

Filters that have cracked or are otherwise damaged from repeated cleaning will allow too much air to pass through. Therefore, filters are also inspected manually to identify cracks, which are particularly important to detect as they allow soot and exhaust by-products to pass through the filter into the atmosphere. Crack inspections are conducted visually. In a conventional crack inspection process a bright light is shined through the filter and visually inspected by looking for areas of more concentrated light, which tend to be evidence of one or more cracks. Dark regions are evidence of clogged areas.

For the high-pressure air inspection technique, the analog air pressure value is read by the operator, recorded by hand, and manually compared against a reference pressure value provided by the filter manufacturer.

The visual inspection for clogs and cracks is also performed by a human operator and is inherently subjective. Consequently, these processes offer ample opportunity for clogged or cracked filters to incorrectly pass inspection.

There are several situations that can lead to such a result, including improper placement of the filter on the fan outlet, incorrect reading of the analog pressure meter, transcription errors, comparison mistakes, lenient or strict visual judgments, or willfully negligent acts of the operator.

Because the manometer references pressure changes to ambient air pressure, changes in barometric pressure can also affect whether a marginal filter passes the air flow test. Additionally, two inspection machines can provide different results simply based on their altitude (i.e., different ambient pressure) and calibration.

There is therefore clearly a need for a standardized process for inspecting and testing a filter, one that removes both human and machine-to-machine errors.

### BRIEF DESCRIPTION OF THE DRAWINGS

The present invention can be more easily understood and the advantages and uses thereof more readily apparent when the detailed description of the present invention is read in conjunction with the figures wherein:

FIG. 1 illustrates a diesel particulate filter inspection machine of the present invention.

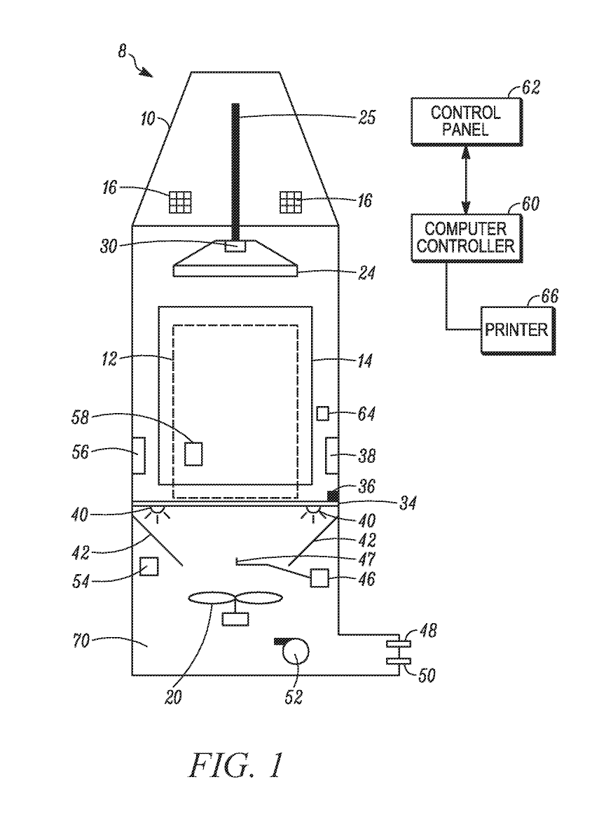

In accordance with common practice, the various described features are not drawn to scale, but are drawn to emphasize specific features relevant to the invention. Like reference characters denote like elements throughout the figures and text.

### DETAILED DESCRIPTION OF THE INVENTION

Before describing in detail the particular methods and apparatuses related to a diesel particulate filter inspection machine, it should be observed that the embodiments of the present invention reside primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments. The presented embodiments are not intended to define limits as to the structures, elements or methods of the inventions, but only to provide exemplary constructions. The embodiments are permissive rather than mandatory and illustrative rather than exhaustive.

### The Diesel Particulate Filter Inspection Machine

The filter inspection machine of the present invention is designed to standardize the process of inspecting a cleaned filter and remove many of the possible opportunities for human error that may affect the outcome of the inspection.

The inspection comprises a two-part process: during the first phase of the test a vacuum is drawn within a cabinet housing the filter and monitored to ensure that the filter is properly seated on a filter support ring and that no leaks are present in the cabinet. The vacuum test also ensures that the operator has not created a secondary flow path, e.g., by placing a shim under the filter to change the airflow during the second or flow test phase of the test. Such a shim would void the test results. The second test phase is intended to measure air flow through the filter. If the measured air flow includes a first contribution from air flow through the filter and a second contribution from air flow through the shimmed region, the air flow results do not represent an accurate measure of air flow through the filter. These distorted test results could pass a filter that otherwise would have failed the test.

In the second phase, the vacuum is released, a fan draws air through the filter, and the inspection machine monitors air flow through the filter to determine whether the filter has been sufficiently cleaned. This phase of the test is referred to as a flow test.

An inspection machine 8 according to the teachings of the present invention is illustrated in the FIGURE and operation described below. Each element of the inspection machine 8 is also illustrated.

Cabinet 10. A diesel particulate filter 12 (dashed lines in the FIGURE) is placed in the cabinet 10 after the filter 12 has been cleaned. A door 14 on the cabinet 10 locks closed to prevent intervention during the testing process.

Intake vents 16. The vents 16 allow air to enter the machine 8 during testing as forced through the filter 12 by a fan 20 disposed in a bottom region of the cabinet 10.

Top seal plate 24. This moveable top seal plate 24 lowers to form an airtight seal across a top surface of the filter 12 during the testing process. The top seal plate 24 is raised and lowered by a computer controller 60 issuing commands to a seal plate positioning rod 25. The top surface of the filter is blocked to draw a vacuum in the cabinet or test chamber 10 by positioning the top seal plate 24 against the top surface. During the flow test phase, the top seal plate is raised to permit air to flow freely through the filter 12.

In a first embodiment, the seal plate 24 as a conical shape and seals around an upper rim of the filter 12 with a ring of pliable rubber material. In a second embodiment, the seal plate 24 comprises a circular plate of pliable rubber material that lowers directly onto the top surface of the filter 12.

Camera 30. The camera 30 is installed in a center region inside the top seal plate 24. In another embodiment, the camera comprises a linear image sensor that is moved across the top surface of the filter 12 by a motor traveling along linear guide rails. The camera 30 takes digital photos of the filter during the inspection process. The camera points downwardly into the filter and can therefore take photos of the ceramic filter element. Dark regions in the image typically indicate clogged areas and light streaks in the image are created by cracks in the ceramic.

Filter support ring 34. The filter 12 rests on a support ring 34 inside the cabinet 10. The support ring 34 defines a hole in the middle of the ring that allows air to flow through the filter and the ring. Because filters 12 have different diameters, a ring with a correct diameter hole is placed inside the cabinet 10 before the filter 12 is placed in the cabinet.

The diameter of the support ring hole is stored in an RFID tag 36 attached to each support ring 34. An RFID tag reader 38 reads the RFID tag 36 to ensure that the support ring 34 with the correct diameter hole is used during the test.

RFID reader 38. The RFID reader 38 reads the RFID tag 36 (when affixed to the filter support ring) to ensure that the correct hole size is used.

Illumination sources 40. The illumination sources 40 comprise high intensity lights that provide illumination during the test and especially while the camera 30 is taking pictures.

Light reflector panels 42. These panels 42 are painted matte white and properly located and positioned to uniformly reflect light emitted from the illumination sources 40 upward into a lower region of the filter 12.

Manometer 46. A manometer 46 measures the air pressure within the cabinet 10 throughout the test. A manometer probe or inlet port 47 is positioned in the airflow stream below the filter.

Vacuum relief valve 48. A vacuum relief valve 48 is electronically actuated open by the computer controller 60 to allow air back into the cabinet 10 after the vacuum phase of the test has been completed. When the top seal plate 24 is lowered and the vacuum is drawn within the cabinet 10, the top seal plate 24 likely cannot be lifted from the filter 12 until the vacuum has been released. Once the vacuum has been released the seal plate 24 is lifted away from the filter.

Pneumatic check valve 50. A pneumatic check valve 50 is a one-way exhaust vent that allows air to exit the cabinet 10 during the testing phase when the fan 20 draws air into the cabinet 10 (test chamber) through the intake vents 16 at the top of the cabinet 10.

Vacuum pump 52. The vacuum pump 52 evacuates air from inside the chamber 10 during the vacuum testing phase.

Fan 10. The high volume, low-pressure fan 10 pulls air through the filter 12 during the testing process.

Barometric pressure sensor 54. The sensor 54 measures ambient air pressure inside/outside the cabinet 10 during the flow test.

Bar code scanner 56. The bar code scanner 56 reads a barcode 58 on a side surface of the filter 12 during the testing process. This barcode includes a unique serial number assigned to the filter and the test results are recorded against that serial number.

Computer controller 60. Operation of the inspection machine 8 is controlled by a processor or a dedicated computer, referred to herein as the computer controller 60. The computer controller is also pre-programmed with a database of airflow values that represent thresholds for passing (failing) the inspection process for each one of a plurality of filter sizes and types.

Control panel 62. Operator controls and machine status indicators are mounted on the control panel 62.

Door lock sensor 64. The sensor 64 advises the computer controller 60 as to a condition of the enclosure door 14, i.e., locked or unlocked.

Various elements of the inspection machine 8 are connected to the computer controller 60 and/or the control panel 62 by wired or wireless connections, which are not shown in the FIGURE.

Printer 66. The printer 66 is connected to the computer controller 60 to print images captured by the camera 30.

### Operation of the Filter Inspection Machine

The general operation of the machine is described below. Generally, first a vacuum is drawn in the chamber 10, the vacuum is released, and air flow is directed through the filter and measured.

An operator measures a diameter of the filter 12 and selects the filter support ring with that diameter, to both support the filter and ensure unrestricted air flow through the filter.

The operator then places the filter into the chamber 10 with the filter's smooth rim edge facing downwardly and orients the filter with the bar code 58 facing the bar code scanner 56.

The operator then closes and locks the door 14.

An automated segment of the test begins when the operator activates a start button on the control panel 62.

The following processes are then executed.

The computer controller 60 confirms the door is closed and locked by checking the door lock sensor 64. If the door is not locked, an error message is displayed on the control panel 62 and the test is stopped.

If the test continues, the RFID reader 38 reads the RFID tag 36 affixed to the filter support ring 34 and records it in the computer controller 60. If the reader 36 is unable to read the RFID tag on the ring, an error message is displayed on the control panel 62 and the testing process stops.

If the test continues, the operator enters the VIN number of the vehicle from which the filter was removed and the vehicle mileage, into the computer controller 60 via the control panel 62.

The inspection bar code scanner 56 reads the barcode 58 on the filter 12. If the barcode cannot be read, an error message is displayed on the control panel 62 and the testing process stops.

If the barcode 58 has been read, the computer controller 60 lowers the top seal plate 24 onto the top of the filter 12 by action of the top seal plate positioning rod 25. A stepper motor (not shown) raises and lowers the plate 24 by controlling the rod 25. A limit switch (not shown) determines an upper limit of the travel of the seal plate 24 and an electronic stall detector (not shown) determines when the seal plate 24 is tightly seated on the filter 12.

The computer controller 60 activates the vacuum pump 52, which draws air out of the chamber 10 to create a vacuum in a region 70 (the location of the vacuum pump of the cabinet 10. 52). Note that a seal (not specifically shown) disposed on a lower surface of the filter 12 rests against the filter support ring 34. The air flow path through the filter is aligned with the opening in the support ring, and the top surface of the filter is sealed by the top seal plate. Thus, in fact a vacuum is also drawn within the filter.

The vacuum is created to ensure the filter is seated properly against the filter support ring 34 and that there has been no willful or negligent interference with the test. For example, to cheat the test results, a test operator may place shims between the lower surface of the filter and the support ring. The shims create a secondary air flow path from the intake vents 16, through the shimmed region, through the opening in the support ring, to the manometer 46, and finally to the fan 20. This secondary path does not include air flow through the filter (the primary flow path) and can thereby distort the test results.

The computer controller 60 monitors an output signal of the pressure sensor 54 while the vacuum pump 52 is operating. When the pressure drops to a specific value, typically 0.5 atmospheres in one embodiment, the vacuum pump 52 is turned off by the computer controller 60. The computer controller continues to monitor the barometric pressure sensor 54 for a period of time, about 30 seconds in one embodiment, to determine if the pressure has changed. If the pressure increases above a specific limit, typically 0.6 atmospheres, an error message is displayed on the control panel 62 and the testing process stops.

If the pressure held steady, the computer controller 60 opens the vacuum relief valve 48 to equalize the pressure inside and outside the cabinet 10.

The computer controller 60 raises the top seal plate 24 thereby allowing air to flow through the filter 12 during the flow test phase.

The computer controller 60 reads the barometric pressure sensor 54 and uses the value to correct the manometer reference point to ISA standard pressure, 29.92″ Hg. This correction is necessary to account for variations in outside air pressures. The fan has a fixed speed. At higher altitudes where the air is thinner, the fan does not draw in as much air as it would at sea level where the air is denser. At high altitudes therefore, the test results may indicate a failed filter (due to lower air flow), when in fact the air flow is lower because of the test altitude and not because the filter is clogged. Consequently, this reference point correction is required to ensure accurate test results.

The computer controller 60 turns on the fan 20 to draw air through the filter 12 from top (the intake vents 16) to bottom (the pneumatic check valve). After the fan has achieved full speed, the manometer value is sampled by the computer controller multiple times, in one embodiment about 16 times, (e.g., four samples in three second intervals between each sample) to determine the amount of airflow through the filter. An average (or another statistical metric) of the samples is calculated by the computer controller 60 and displayed on the control panel 62.

While measuring the airflow, the computer controller 60 turns on the illumination sources 40 and takes photographs of the filter 12 using the camera 30. As can be seen in the FIGURE, light from the illumination sources 40 is directed downwardly toward the reflectors 42, and the reflected light is directed upwardly toward a lower region of the filter 12. Each photo is stored as a digital file in the computer controller 60.

After taking the air flow samples, the computer controller 60 turns the fan 20 off and displays a message on the control panel that the test has been completed.

The computer controller 60 then compares an average airflow value (or one or more of the actual/measured air flow values) measured from the test, with a predetermined and stored database of threshold values to determine if the measured value is within an acceptable or passing range of the threshold value. A measured airflow value below the threshold value indicates that the filter remains clogged and requires another cleaning. Generally, several different threshold values are stored as each represents a threshold value for differently-sized openings in the filter support ring 34.

The computer controller 60 also performs an analysis of the photographic images to determine if any cracks or clogs are present within the filter 12. The digital photographs may be processed with a contrast enhancement filter to enhance contrast, an unsharp mask filter to increase sharpness, and an edge detection filter that emphasizes any cracked regions.

After image filtering, two image processing algorithms are used: the first identifies clogged areas and the second identifies cracks.

Clogs are determined by looking for contiguous areas of pixels, e.g. ten or more pixels, with a low luminance value, e.g. under 25 in an 8-bit pixel system. If 50 or more clogs are detected, the filter is rejected and must be re-cleaned. Alternatively, if 20% or more of the total pixels in the filter image have low luminance, e.g. under 25 on an 8-bit system, the filter also does not pass inspection and must be re-cleaned.

Cracks are determined by looking for contiguous lines of bright pixels, e.g. ten or more pixels with similar luminance values on two sides of a photographic feature, e.g. over 175 in an 8-bit system. If contiguous bright pixels longer than 100 pixels are identified, or more than three groups of contiguous bright pixels longer than 50 pixels are identified, the filter is considered to have cracks and must be replaced.

The numerical values set forth above reflect a single embodiment of the system and can be changed in other embodiments to improve system performance.

A final filter pass or fail message is displayed on the control panel 62. If the result is a test failure, the reason for failure is displayed: clogged, cracked and/or insufficient airflow. Both the air flow rate and the image analysis are considered in the pass/fail determination.

The computer controller 60 determines that the filter 12 has passed inspection, in one embodiment, only if the airflow value is within a desired range (i.e., above a predetermined threshold). In another embodiment both the airflow value and the presence or absence of cracks and clogs are used to determine a pass or fail conclusion for the filter.

What is claimed is:

1. A diesel particulate filter inspection machine comprising:
a test chamber for receiving a diesel particulate filter;
a fan for drawing air from outside the chamber through the filter; and
an air flow measuring device for measuring air flow through the filter and comparing a measured air flow with a predetermined air flow threshold value to determine whether the diesel particulate filter needs further cleaning.

2. The diesel particulate filter inspection machine of claim 1 further comprising a camera for creating filter images and an image analyzer for analyzing the images and for detecting cracks and clogged regions in the filter from the filter images.

3. The diesel particulate filter inspection machine of claim 1 the air flow measuring device further comprising a manometer indicating air flow through the filter responsive to a pressure differential between a pressure outside the test chamber and a pressure inside the chamber.

4. The diesel particulate filter inspection machine of claim 3 wherein the fan is disposed below the diesel particulate filter for drawing air down through the filter and through a manometer inlet port disposed between the fan and a bottom surface of the filter.

5. The diesel particulate filter inspection machine of claim 3 further comprising a barometric sensor for determining an outside pressure outside the test chamber, the outside pressure for use in calibrating the manometer.

6. The diesel particulate filter inspection machine of claim 1 further comprising a support ring disposed within the test chamber and defining a central opening therein, the filter for resting upon the support ring.

7. The diesel particulate filter inspection machine of claim 6 a tag affixed to the support ring and carrying information related to a size of the central opening, the tag for communicating with a tag reader for reading a value indicating the size of the central opening, a computer controller responsive to the tag reader for comparing a size of the central opening with a size of an air flow path through the filter.

8. The diesel particulate filter inspection machine of claim 1 further comprising a vacuum pump for drawing a vacuum within a region of the test chamber prior to a step of activating the fan for drawing air through the filter.

9. The diesel particulate filter inspection machine of claim 8 further comprising a vacuum relief valve for releasing the vacuum.

10. The diesel particulate filter inspection machine of claim 1 further comprising illumination sources for illuminating an interior region of the filter.

11. The diesel particulate filter inspection machine of claim 10 further comprising reflector panels, light beams from the illumination sources reflecting from the reflector panels into the interior region of the filter.

12. The diesel particulate filter inspection machine of claim 1 further comprising a pneumatic check valve for allowing air to exit the test chamber after flowing through the filter.

13. The diesel particulate filter inspection machine of claim 1 further comprising a reader for reading information carried on the diesel particulate filter, the information comprising a number uniquely identifying the diesel particulate filter.

14. The diesel particulate filter inspection machine of claim 1 further comprising intake vents disposed on an upper surface of the test chamber, the fan for drawing air from outside the chamber through the intake vents and through the filter.

15. The diesel particulate filter inspection machine of claim 1 further comprising a top seal plate for positioning over and sealing a top surface of the filter prior to a step of drawing a vacuum within a region of the test chamber.

16. The diesel particulate filter inspection machine of claim 1 further comprising a computer controller for controlling a pump for drawing a vacuum within a region of the test chamber, for activating the fan for drawing air through the filter, for controlling a camera to create images of the filter, for analyzing filter images, for controlling a device for measuring of air flow through the filter, and for determining a condition of the filter responsive to a measured air flow and results from analysis of the filter images.
